(19) United States
(12) Patent Application Publication
(10) Pub. No.: US 2004/0104315 A1
(43) Pub. Date: Jun. 3, 2004

(54) Mounting strip for utility lines and connecting links in a boat

(76) Inventor: George Betz, Milford, CT (US)

Correspondence Address: Patrick J. Walsh, Esq.,, 400 Main Street, Stamford, CT, 06901, US

(21) Appl. No.: 10/308,451

(22) Filed: Dec. 3, 2002

(51) Int. Cl. F16L 3/08

(52) U.S. Cl. 248/74.2; 248/51

(57) ABSTRACT

A mounting strip for installing utility lines and connecting links in a marine vessel in the form of an elongate flexible strip having confronting lateral wall members extending along the strip to define an elongate channel for receiving and protecting utility lines and connecting links deployed in the vessel.

### BACKGROUND OF THE INVENTION

The present invention relates to utility lines such as electric power lines, air and fluid lines, and connecting links such as speedometer cables and the like and particularly to providing a mounting strip for securing these lines and links to supporting surfaces such as decks and bulkheads of marine vessels and other locations where the lines and links may be deployed.

A power boat is normally fitted with operating equipment that requires the placement of utility lines or connecting links between separate components of operating equipment. For example, a transducer cable or speedometer tubing extends between an overboard pickup component and a gauge or indicator located in the wheelhouse or operating console of the boat. Usually these connecting links are routed through holes penetrating the hull and held in place with nails, screws or mechanical fasteners that penetrate boat structure.

Drilling a hole through a boat's transom tends to compromise the watertight integrity of the boat, disfigures the boat, and is contrary to the most basic instincts of a seaman regarding his boat.

Connecting links and utility lines deployed along deck and bulkhead and held in place by screws or mechanical fasteners can easily snag fishing lines or hooks and other things commonly used in power boats causing annoyance to the user, and sometimes causing damage to the link or line.

The present invention is particularly concerned with such utility lines and connecting links deployed in power boats and provides proper mounting for such lines and links along their entire length so as to secure such lines links to deck and bulkhead, to protect such lines and links from damage and disturbance, to provide a shipshape appearance, and to enable installation of such lines and links without drilling holes through watertight bulkheads and transom of the boat and without affixing mechanical fasteners with screws or nails.

### SUMMARY OF THE INVENTION

The present invention is directed to a mounting strip for receiving and supporting utility lines and connecting links along their entire length between end connections to operating equipment of which the line or link forms a part.

The mounting strip according to the invention comprises an elongate member defining a base for attachment to a supporting structure such as a bulkhead, and upright, confronting walls defining an elongate channel for receiving lines or links deployed in the boat.

In preferred form the mounting strip is a unitary extruded elongate member with a relatively broad base, and upright slightly arcuate confronting sidewalls defining a channel into which a utility line or connecting link is inserted for operating deployment. The sidewalls are effective to engage and protect substantially the entire body of the line or link protecting them from damage or disturbance. In addition, structural and watertight members of a boat need not be compromised or damaged by puncture or application of mechanical fasteners and unsightly and damaging screws and nails.

Specific examples are included in the following description for purposes of clarity, but various details can be changed within the scope of the present invention.

### OBJECTS OF THE INVENTION

An object of the invention is to provide for support and protection of utility lines and connecting links particularly those employed in marine vessels.

Another object of the invention is to provide a mounting strip for continuous support and protection of utility lines and connecting links especially those in marine vessels.

Another object of the invention is to provide an elongate extruded strip suitable for securing by adhesive to structural components of a vessel and having one or more protective channels for receiving utility lines or connecting links extending between operating equipment of the vessel.

Other and further objects of the invention will become apparent with an understanding of the following detailed description of the invention or upon employment of the invention.

### BRIEF DESCRIPTION OF THE DRAWING

A preferred embodiment of the invention has been chosen for detailed description to enable those having ordinary skill in the art to which the invention appertains to readily understand how to construct and use the invention and is shown in the accompanying drawing in which:

FIG. 1 is perspective view of a preferred embodiment of mounting strip according to the invention.

FIG. 2 is an enlarged end view of the mounting strip of FIG. 1.

FIG. 3 is perspective view of a modified embodiment of mounting strip according to the invention.

FIG. 4 is a slightly enlarged end view of the mounting strip of FIG. 3.

### DETAILED DESCRIPTION OF THE PREFERRED EMBODIMENT

Referring to the drawing, a mounting strip 10 according to the invention comprises a unitary elongate member having a planar, generally rectangular base 12 with lateral edges 14, 16 and a top surface 18 that begins at opposite lateral edges and gradually rises in a curvilinear cross section (FIG. 2) toward the center of the strip to define a pair of curved, confronting, flexible lateral walls 20 defining between them a generally cylindrical channel 22 with an open top 22a for receiving a utility line or a connecting link L. The lateral walls 20 each rise from the base 12 portion of the strip in an outer lateral wall surface 20a that curves upwardly and inwardly to an apex 20b toward the center of the strip, and an inner wall surface 20c that is preferably cylindrical so as to form an undercut 20d behind the lateral wall and to extend downwardly toward the base 12 of the strip.

The result is a strip with a substantially identical formed flexible pair of lateral walls defining an elongate preferably cylindrical channel for receiving a line or link and for protecting the line or link as it extends along a boat surface from damage inflicted by any person or thing touching the line or link. As shown in FIG. 2 the lateral walls receive and embrace substantially the entire perimeter of line or link L.

An adhesive A is applied to the base of the strip for securing the strip to a bulkhead or other structural surface of the boat.

If desired, an adhesive A′ may be applied to the channel surface as an aid in retaining a line or link within the channel.

The mounting strip is preferably fabricated by extrusion of a flexible tough plastic for protection of line and link against the wear and tear occurring in operation of a pleasure boat or working boat. The confronting lateral walls flex outwardly to receive a line or link and flex inwardly as in FIG. 2 after line or link installation.

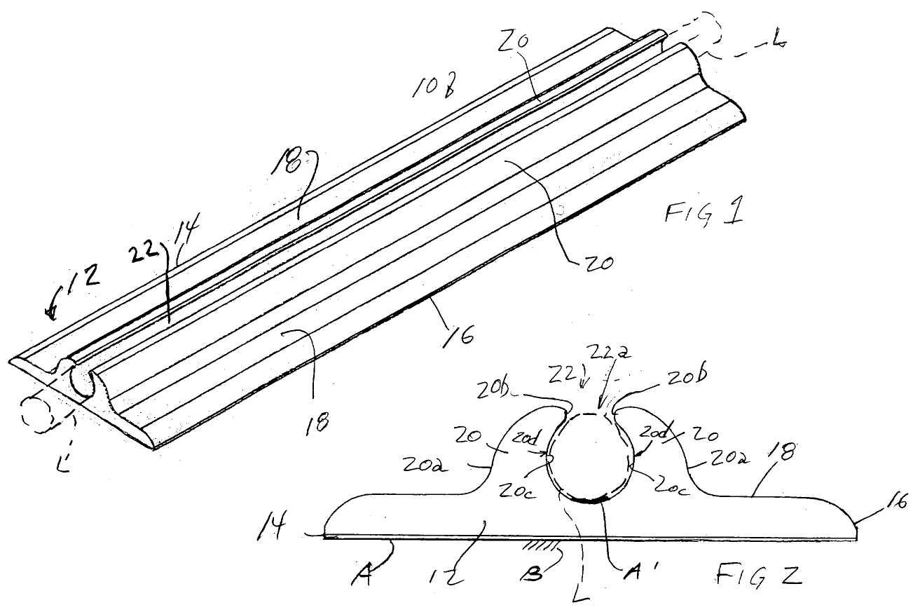

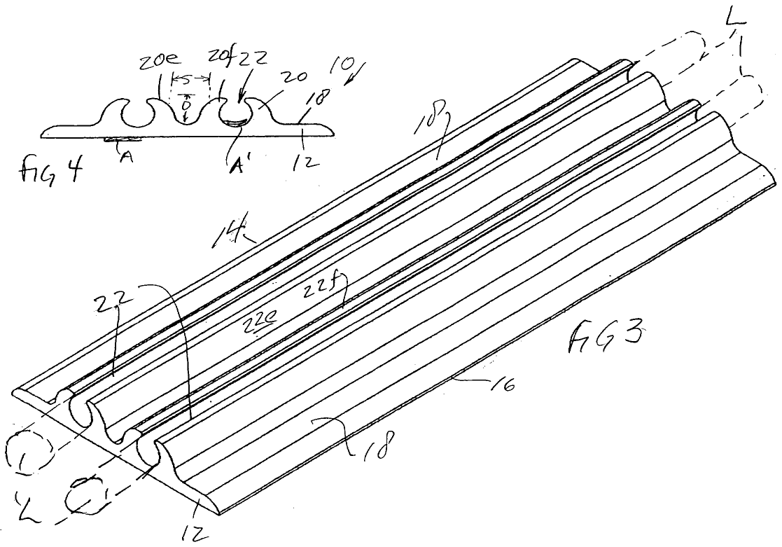

A modified embodiment of the invention is shown in FIGS. 3 and 4 in which a plurality of protective channels are formed in a protective strip. The plurality of pairs of lateral walls and channels are substantially the same as the embodiment of FIGS. 1 and 2 as indicated by common reference numerals. The interior back-to-back lateral walls 20e and 20f have sufficient spacing S and depth of recess D there-between to ensure desired flexibility of the back-to-back walls for installing and retaining a line or link.

In use, a protective strip according to the invention is secured by adhesive along a proposed path for a utility line or connecting link between operating components of boating equipment such as a fuel line extending between fuel tank and engine, or a connecting cable or link between a overboard speed transducer and a pilot house speedometer. Then the line or link is shaped and inserted into the mounting strip channel preferably using and adhesive to retain the line or link in the channel.

The mounting strip enables users to fasten a transducer cable or speedometer tubing to a transom without penetrating a boat hull with nails, screws or mechanical fasteners. In the specific case of a fish finder, a transducer is fitted to the outboard side of a boat transom in position to emit a sonar signal into the water. An electric cable connects the transducer to a depth sounder CRT located in the pilot house or operating console of the boat. In accordance with the invention, the mounting strip is secured to the boat along the path selected for the electric cable, and the cable is snapped into the mounting strip channel being affixed therein with adhesive if desired. There is no need to modify the cable in any way, and there is no need to pierce the boat hull or transom.

The strip provides a very low continuous profile with a clean and neat appearance so as to prevent entanglement of fishing lures and hooks. The open flexible strip allows for easy installation and removal of electric cable without the need to alter either end of the cable. The strip can also be used on interior boat surfaces or bulkheads for a neat and clean appearance.

Various changes may be made to the structure embodying the principles of the invention. The foregoing embodiments are set forth in an illustrative and not in a limiting sense. The scope of the invention is defined by the claims appended hereto.

I claim:

1. A mounting strip for installing utility lines and connecting links in a marine vessel comprising an elongate flexible strip having a planar base surface for mounting the strip along a boat surface, the strip having confronting lateral wall members extending along the strip, the lateral wall members having interior surfaces cooperating to define an elongate channel for receiving and protecting utility lines and connecting links deployed in the vessel.

2. A mounting strip for installing utility lines and connecting links in a marine vessel comprising an elongate flexible strip having a planar base surface for mounting the strip along a boat surface, the strip having confronting lateral wall members extending along the strip, the lateral wall members having interior surfaces cooperating to define an elongate channel for receiving, and protecting utility lines and connecting links deployed in the vessel, and the lateral wall members being flexible for engagement of said lines and links for retaining them within the channel.

3. A mounting strip for installing utility lines and connecting links in a marine vessel comprising an elongate flexible strip having a planar base surface for mounting the strip along a boat surface, the strip having confronting lateral wall members extending along the strip, the lateral wall members having interior surfaces cooperating to define an elongate channel for receiving, and protecting utility lines and connecting links deployed in the vessel, and the lateral wall members being flexible for engagement of said lines and links for retaining them within the channel.

4. A mounting strip for installing utility lines and connecting links in a marine vessel comprising an elongate flexible strip having:
a planar base surface for mounting the strip along a boat surface, the planar base being defined by opposite lateral edges,
a top surface that begins at opposite lateral edges and gradually rises in a curvilinear cross section toward the center of the strip to define a pair of curved, confronting flexible lateral walls,
the lateral walls each rising from the base portion of the strip in an outer lateral wall surface that curves upwardly and inwardly toward the center of the strip,
the lateral walls further having a cylindrical inner wall surface undercutting the lateral wall and extend downwardly toward the base of the strip,
the lateral wall members having interior surfaces cooperating to define the elongate channel for receiving and protecting utility lines and connecting links deployed in the vessel, and the lateral wall members being flexible for engagement with said lines and links for retaining them within the channel.

5. A mounting strip as defined in claim 4 having a plurality of pairs of lateral wall members defining a plurality of channels for receiving utility lines and connecting links.

6. A mounting strip for installing utility lines and connecting links in a marine vessel comprising an elongate flexible strip having a planar base surface for mounting the strip along a boat surface, the strip having a plurality of pairs of confronting lateral wall members extending along the strip, the pairs of confronting lateral wall members having interior surfaces cooperating to define an elongate channel for receiving and protecting utility lines and connecting links deployed in the vessel.
